(19) United States
(12) Patent Application Publication
(10) Pub. No.: US 2011/0104394 A1
(43) Pub. Date: May 5, 2011

(54) PROCESS FOR THE PERMANENT MULTICOLOR PAINTING OF A PRODUCT

(75) Inventors: BERNARD BEIER, LADENBURG (DE); GERALD ERIK HAUPTMANN, BAMMENTAL (DE); HEINER PITZ, WEINHEIM (DE); MATTHIAS SCHLÖRHOLZ, PLANKSTADT (DE)

(73) Assignee: HEIDELBERGER DRUCKMASCHINEN AG, HEIDELBERG (DE)

(21) Appl. No.: 12/940,287

(22) Filed: Nov. 5, 2010

(30) Foreign Application Priority Data
Nov. 5, 2009 (DE) 10 2009 052 137.2
Mar. 1, 2010 (DE) 10 2010 009 767.5

(51) Int. Cl. B05D 3/06; B05D 1/00

(52) U.S. Cl. 427/535; 427/532; 427/256; 427/558

(57) ABSTRACT

A process for the permanent multicolor painting of a product, e.g. a body part, includes defining a first region, a first location within the first region and a second location within the first region but different from the first location, on the surface of the product. The surface is provided with a first release layer, at least in the first region and the first release layer is exposed to electromagnetic radiation, e.g. IR radiation, at the first location but not at the second location. The surface is provided with a first layer of paint at least at the first location. The first layer of paint is fixed, at least at the first location. Alternatively, the first release layer is applied at least at the second location but not at the first location, so that an exposure to electromagnetic energy at the first location can be omitted.

### CROSS-REFERENCE TO RELATED APPLICATION

This application claims the priority, under 35 U.S.C. §119, of German Patent Applications DE 10 2009 052 137.2, filed Nov. 5, 2009, and DE 10 2010 009 767.5, filed Mar. 1, 2010; the prior applications are herewith incorporated by reference in their entirety.

### BACKGROUND OF THE INVENTION

### Field of the Invention

The present invention relates to a process for the permanent multicolor painting of a product.

It is known from the area of industrial painting, such as in automobile production or in the case of “white goods,” automatic drink dispensers, metal facades and so on, to paint metal sheets or plastic surfaces, that is to say to provide them permanently or durably with paint, in order to protect the parts both against corrosion and damage in the long term, i.e. over years, and also to make them visually attractive. It is also already known to provide such parts not just with a single paint but with two paints of different colors in two operations. To that end, the paint applied first is partly masked before the second painting with a different color. Such a process is laborious, time-consuming and costly.

German Published, Non-Prosecuted Patent Application DE 10 2008 053 178 A1 describes a painting device for painting motor vehicle body components, in which a printhead having at least one nozzle, for example a BubbleJet or a piezoelectric printing head, is used to apply the paint. It is possible for CMYK primary colors and special colors to be processed and, at the same time, for decorative paint jobs to also be produced. The printhead can have a matrix of nozzles and rotate during printing. The intention is for so-called overspray, that is to say paint that is sprayed but not applied, to be reduced or avoided and therefore to dispense with separate washing out of the overspray from the painting cubicle air. The device has one or more color changers and a plurality of painting agent feed lines, so that it must be supposed that there is some effort required for cleaning.

It is additionally already known from the area of the graphic industry, which is remote therefrom, in particular in offset printing, to image printing forms and to ink them temporarily and reversibly, in order to transfer the applied printing ink from the printing form to a substrate (e.g. paper or board). Following the printing, the printing forms can be cleaned completely of ink and possibly reused. Normally, the substrates are printed in multiple colors, which means that use is made of a plurality of printing forms, which are inked differently. In the course of the imaging, the printing forms are structured in accordance with the image data to be printed, which means that ink-accepting and ink-repelling regions are created on the surface, e.g. with the aid of laser radiation. One type of structuring includes the structured and locally resolved nanoscopic covering of the printing form with amphiphilic molecules, for example in the ink-accepting regions.

In addition, from the graphic industry it is already known to dry or to cure the printing inks transferred in that way on the substrate and it is possible for UV or IR radiation (also as laser radiation) to be used.

### SUMMARY OF THE INVENTION

It is accordingly an object of the invention to provide a process for the permanent multicolor painting of a product, which overcomes the hereinafore-mentioned disadvantages of and is improved as compared with the heretofore-known processes of this general type and which makes it possible to paint products such as body parts permanently and with many colors, in such a way that the effort required during color changes is low and entails little effort for cleaning.

With the foregoing and other objects in view there is provided, in accordance with the invention, a process for the permanent multicolor painting of a product. The process comprises:

A) defining a first region, a first location within the first region and a second location within the first region but different than the first location, on a surface of the product;
B1, B2) providing the surface with a first release layer at least in the first region, and exposing the first release layer to electromagnetic radiation at the first location but not at the second location;
C1) providing the surface with a first layer of paint, at least at the first location; and
D) fixing the first layer of paint, at least at the first location.

With the objects of the invention in view, there is also provided, as an alternative, a process for the permanent multicolor painting of a product. The process comprises:

A) defining a first region, a first location within the first region and a second location within the first region but different than the first location, on a surface of the product;
B1) providing the surface with a first release layer, at least at the second location but not at the first location, by using an application device;
C1) providing the surface with a first layer of paint, at least at the first location; and
D) fixing the first layer of paint, at least at the first location.

### DEFINITIONS OF TERMS

I) In this application, as opposed to the merely temporary inking of printing forms for the purpose of the subsequent transfer of ink, the term “permanent painting” is understood to mean the permanent painting or application of a paint, varnish or ink, with the cured paint or the ink being resistant to wiping and thus not being removable from the substrate again without damage or without destruction, i.e. in other words: removal necessarily leads to damage to or destruction of the paint/the ink and/or even the substrate.

II) In this application, the term “product” is understood to mean a substrate having at least one solid surface which is able to carry permanent paint. The substrate and/or the materials of the substrate can be painted, finished, primed, filled or varnished, at least in some regions.

Suitable substrates (list of exemplary embodiments):

1. metal sheets
1.1 e.g. galvanized;
1.2 e.g. substantially made of stainless steel, aluminum or magnesium;
   2. metal composite materials
2.1 e.g. aluminum-steel composite, magnesium aluminum steel composite or “Bondal” from ThyssenKrupp;
   3. fiber reinforced plastics
3.1 e.g. glass fiber reinforced plastics (GRP);
3.2 e.g. carbon fiber reinforced plastics (CRP);
3.3 e.g. natural fiber reinforced plastics (NRP) such as polylactides (PLA) reinforced with kenaf;
   4. wood-plastic-composites (WPC), i.e. wood-plastic composite materials or wood-polymer materials;
   5. plastics (PE, HDPE, PVC, PS);
   6. glass.

III) In this application, the term “release layer” is understood to mean one of the layers or coverings listed below under the numbers 1 to 6. The choice of a specific release layer can be made depending on whether the paint to be applied is solvent-based or water-based and whether the paint to be applied is intended to wet the release layer well, poorly or substantially not at all.

According to the invention, use is made of a release agent which produces a release layer temporarily on the substrate. The release layer can be a paint-repelling intermediate layer. However, it is at least not detached or damaged by a layer of paint applied subsequently. This release layer is intended to be as resistant as possible and locally stable up to the point where usual paint drying temperatures of about 60-200° C. are reached. The release layer can be applied over an area and subsequently locally removed or modified (e.g. through the use of preferably laser-generated IR radiation or UV radiation). Alternatively, the release layer can be applied locally.

1. A wax or oil layer, i.e. a microscopic layer (layer thickness preferably less than about 100 micrometers, more preferably less than about 10 micrometers), at least including: wax or oil, preferably a wax containing PTFE (Teflon®) or silicone and/or preferably a wax with low flow characteristics.

Suitable substances/agents (list of exemplary embodiments):
1.1 water-based outer skin preservative W550 and solvent-based preservative wax Apex 106 II from the firm Pfinder in Böblingen, Germany (see the Pfinder website);
1.2 cavity sealant “Fertan HT” or “Fertan NT10” from the firm Fertan in Saarbrücken, Germany (see the Fertan website);
1.3 Teflon-containing spray wax “Fin Grease” and the products “Fin Film WB” or “Wax-Spray” from the firm Interflon in Nettetal, Germany (see the Interflon website); or Teflon grease from the firm Gescha in Nagold, Germany;
1.4 aqueous microwax suspension, e.g. “Antiparoli Temporar” from the firm Coverax-M-Chemie in Altdorf, Germany (see the Coverax website); or
1.5 commercially available automobile finish polishes, e.g. “Sonax Xtreme Wax 1 Full Protect” from the firm Sonax in Neudort, Germany (see the Sonax website) or “Nigrin Nanotec hard wax polish” from the firm Inter-Union Technohandel in Landau, Germany (see the Nigrin website).

2. A molecular covering, i.e. a nanoscopic layer (layer thickness preferably less than about 100 nanometers, more preferably less than about 10 nanometers) of molecules, preferably a monolayer.

Suitable substances/agents (list of exemplary embodiments):
2.1 semi-perfluorophosphonic acid;
2.2 polyether siloxane, e.g. “Evonik Tego Glide 410” from the firm Evonik Tego Chemie (see the Evonik Tego website);
2.3 fluorinated oligomeric siloxane in organic solvent, e.g. “Graffitischutz HM 050” from the firm Coverax-M-Chemie in Altdorf, Germany (see the Coverax website); or
2.4 aqueous nanodispersion, e.g. “Nanotol” from the firm CeNano in Dorfen, Germany (see the Cenano website).
3. A sol-gel system or a layer produced by a sol-gel process, preferably a sol-gel system which is touch-proof after a few minutes (period preferably less than about 10 minutes, more preferably less than about 5 minutes) and/or which (counter to otherwise mostly conventional requirements on sol-gel systems) exhibits only little wear resistance.

Suitable substances/agents (list of exemplary embodiments):
3.1 single-component and multi-component systems; or
3.2 solvent-based and water-based systems, preferably products containing polysiloxane, vinyl or fluorine, e.g. “H5044” from the firm FEW Chemicals in Bitterfeld-Wolfen, Germany (see the Few website).

4. One of the following layers:
4.1 a polymer or resin layer, preferably an aqueous suspension with vinyl resin, e.g. “Flüssige Abdeckfolie” [Liquid masking Film] from 3M Deutschland in Neuss, Germany (see Solutions on the 3M Deutschland website);
4.2 water-based stove paints, e.g. “Tacky Booth Paint 10W”, “Tacky Booth Paint 10HT” or the polymer-based product “Oven Paint 1493” from the firm General Chemicals in Brighton Mich., USA (see the Paint Booth Chemicals website);
4.3 water-dilutable peel paint “Peel White” or “Peel Clear” from the firm Gescha in Nagold, Germany; or
4.4 solvent-free dust binding paint “Staubfix SBL 6830” from the firm Briel in Giengen, Germany.

5. A multilayer system or multiple covering, preferably using at least one layer and/or covering according to the preceding numbers 1 to 4. A multiple covering can include, for example, a first molecular covering which bonds well to the substrate and a second molecular covering which bonds well to the first molecular covering and exhibits or produces the desired surface property (preferably an adequately repelling property or moisture repellence) with respect to subsequently applied substances/agents.

Suitable substances/agents (list of exemplary embodiments):
5.1 the first layer/covering can be, for example, a polyethylene imide or the “Flüssige Abdeckfolie” [Liquid masking Film] from 3M-Deutschland in Neuss, Germany; and
5.2 the second layer/covering can be a carbonic acid, preferably a stearic acid, or a partly fluorinated or perfluorinated carbonic acid, preferably a perfluorooctanic acid or the solvent-based preservative wax “Apex 106 II” from the firm Pfinder in Böblingen, Germany.

6. The release layers of the preceding numbers 1 to 5 can additionally contain additives in order to improve their function.

Suitable substances/agents (list of exemplary embodiments):
6.1 pigments or dyestuffs in order to absorb laser radiation (e.g. acetylene flame carbon black or other carbon black preparations such as “Luconyl NG Schwarz 0066” from the firm BASF AG, Germany, immonium salts, pyrrelene or cyanine such as “S2058” or “S0837” from the firm FEW Chemicals)
6.2 substrate wetting additives in order to increase the wetting of the release agent on the substrate (e.g. siloxane-containing “Evonik Tego Wet 240” or “Evonik Twin 4100”)
6.3 gelling agents, in order to prevent flow upon heating—e.g. “Tixogel”® (see the Rockwood Additives website)

IV) In this application, the term “application device” is understood to mean a device which permits a release layer to be applied to an area or locally, i.e. locally resolved, preferably a jet nozzle or droplet nozzle. A suitable application device must accordingly permit the substances/agents needed for the production of the release layer to be applied only at specific points of the product, the image points, while the complementary non-image points remain substantially free of these substances/agents.

The process according to the invention preferably has a high level of automation, which can be achieved through the use of controllable and/or movable application devices, e.g. through the use of those which are mounted on movable robot arms.

Suitable application devices (list of exemplary embodiments):
1. mist-producing devices, preferably rotary atomizers, pneumatic atomizers or compressed air atomizers, with or without electrostatic charging and also with or without potential isolation;
2. jet-producing or droplet-producing devices, preferably continuously operating jet nozzles or intermittently operating droplet nozzles, e.g. based on so-called inkjet systems or valve jet systems:
2.1 “continuous ink jet” systems (CU), e.g. from the firm Inkdustry in Neubrunn, Germany;
2.2 “drop on demand” (DOD), in particular “BubbleJet” or “PiezoJet” systems, e.g. from the firms Xaar (see the Xaar website), Konica Minolta (see the Konica Minolta Inkjethead website) or Fuji (se the Dimatix website);
2.3 airbrush systems; and
2.4 droplet metering systems, spray metering or thread metering systems and also hot melt systems, for example from Robatech (see the Robatech website) and Delo Industrieklebstoffe (see the Delo website) or based on the “Rapid Reaction Valve” from GSR Ventiltechnik (see the Ventiltechnik website).

VI) In this application, the term “fixing” is understood to mean a treatment of a layer, preferably a layer of paint, carried out as a process step, as a result of which the layer either adheres permanently to a surface or adheres adequately to a surface in such a way that that layer adheres to the surface at least as far as a process step carried out subsequently which ensures that the layer adheres permanently to the surface. The fixing can be carried out by heating, drying, curing and/or stoving. For instance, a layer of paint can be at least partly cured by heating to such an extent that the layer adheres sufficiently long and firmly to a surface until it is bonded permanently to the surface in a stoving operation carried out subsequently.

VII) In this application, the term “paint” is understood to mean both substantially a colorless, translucent, lasering or transparent paint (for example clear varnish) and also a colored or opaque paint (e.g. top coat).

Suitable paints (list of exemplary embodiments):

1. water-based or solvent-based systems;
2. “High-Solid” systems with a low proportion of solvent;
3. single-component or multi-component systems;
4. powder coatings;
5. hot melt systems;
6. oxidatively drying systems (cross-linking with the participation of atmospheric oxygen);
7. physically drying systems (evaporation);
8. radiation-curing systems (electron beam curing or UV-curing systems with the participation of initiators).

VIII) In this application, the term “highly resolved” is understood to mean a resolution of at least 10 dpi (corresponding to a dot size/edge sharpness of about 2.54 mm). For very many applications, such as multicolor painted vehicle body parts, a resolution of about 100 dpi is sufficient (corresponding to a dot size/edge sharpness of about 0.254 mm).

IX) In this application, the term “location”, apart from a section of the surface of the product (at least a few square centimeters in size), is also understood to mean an individual screen dot (only a sub-square millimeter in size) or an individual screen line (in general: a screen element).

Carrying out the processes according to the invention advantageously permits products to be painted with many colors and permanently, with structuring of the surface being carried out through the use of a release agent: locations on the surface with release agent permit the removal of applied paint, while locations without release agent do not permit such removal, at least following fixing of the paint. A simple example: if a first location is painted red and a second location is not, then release agent is provided at the second location before both locations are painted red and the red paint at the second location is removed again, possibly with the release agent.

According to the invention, the structuring can be carried out in such a way that the release agent is applied in a substantially unstructured manner, i.e. without local resolution (in the above simple example: at both locations), and is removed again in a structured manner (in the above simple example: only at the first location).

Both processes are configured in such a way that they permit the subsequent removal of the excessively applied paint. In addition, both processes are configured in such a way that they can in each case be carried out repeatedly one after the other and, in this way, permit the multicolor painting. In the above simple example: following the painting with red paint, a third location is to be painted blue and a fourth location is not. Release agent is provided at the fourth location before both locations are painted blue and the blue paint is removed again at the fourth location. If the blue paint is not intended to cover the red one, then the fourth location will include the first location.

When paints with identical or at least similar processing are used, it is advantageously possible to operate with only one release agent or a few but likewise similar release agents, so that the expenditure during multicolor painting is kept low. Simple example: if all differently colored paints can be processed with the same release agent, the application device for the release agent does not need to be cleaned for a color change.

The application of the paints is always carried out in a substantially unstructured manner, so that no complicated application devices needing intensive cleaning, e.g. inkjet systems, need to be provided for this purpose. Instead, simpler nozzles producing spray mist can be used. The appearance of painted surfaces accordingly corresponds to the current painting processes with identical application (e.g. rotary atomizers) and process management, even in the case of metallic paints.

The processes according to the invention can in each case be applied as an integrated process step during the otherwise unchanged production or painting/priming of the product, e.g. a vehicle body or a part thereof. Alternatively, the processes can in each case be applied as a subsequent finishing step for an already painted or primed product, and provide the product with additional colors and, as a result, at least visually enhance the same.

According to the invention, the products can be painted with many colors, i.e. with at least two differently colored paints, and permanently. It is additionally possible, apart from simple two-colored paints, such as stripes of one color on a differently colored area, also to produce, for example, screened CMYK images (with the four colors: C=cyan, M=magenta, Y=yellow, K=black) on the products. In practical terms: according to the invention, it is possible not only to produce rally stripes, as they are known, sharp-edged texts and pictograms on body parts but also, for example, highly resolved and complex motifs.

As a result of the production of images and areas including screen dots (printing principle), a comparatively large color space can be depicted from primary hues. The color space can be covered by additive color mixing (screen dots beside one another, opaque colors) and by subtractive color mixing (screen dots cover one another, lasering colors), as well as by both color mixing processes in combination.

In accordance with another mode of the process of the invention, that is advantageous for multicolor painting and is therefore preferred, at the start of the process, a surface having a base layer of paint, at least within the first region, is provided, with the base layer of paint and the first layer of paint having different colors.

In accordance with a further mode of the process of the invention, that is advantageous for permanent painting and is therefore preferred, at the end of the process, permanent fixing of the first layer of paint is carried out, for example through the use of electromagnetic irradiation.

In accordance with an added mode of the process of the invention, that is advantageous in order to permit the unstructured application of paint and is therefore preferred, in a step C2) the surface is provided with a first layer of paint, at least at the second location, and in a step E1) the first layer of paint at the second location is at least partly removed, for example by cleaning.

In accordance with an additional mode of the process of the invention, that is advantageous for multicolor painting and is therefore preferred, in a step E2) the first release layer, separately or together with the first layer of paint, at the second location is at least partly removed. The release-layer-free painted surface of the product is then ready for further painting.

In accordance with yet another mode of the process of the invention, that is advantageous for multicolor painting in the repeated painting process and is therefore preferred, in a step F) on the surface, a third location within a second region and a fourth location within the second region but different from the third location are defined; in steps G1, G2) the surface is provided with a second release layer, at least in the second region and the second release layer is exposed to electromagnetic radiation at the third location; in steps H1, H2) the surface is provided with a second layer of paint, at least at the third and at the fourth locations, the first layer of paint and the second layer of paint having different colors; in a step I) the second layer of paint is fixed, at least at the third location; and in steps J1, J2) the second layer of paint and the second release layer, separately or together with the second layer of paint, at the fourth location, are at least partly removed.

In accordance with yet a further mode of the process of the invention, that is likewise advantageous for multicolor painting in the repeated painting process and is therefore preferred, in a step F) on the surface, a third location within a second region and a fourth location within the second region but different from the third location are defined; in a step G1) the surface is provided with a second release layer, at least at the fourth location, by using an application device; in steps H1, H2) the surface is provided with a second layer of paint, at least at the third location and at the fourth location, the first layer of paint and the second layer of paint having different colors; in a step I) the second layer of paint is fixed, at least at the third location; and in steps J1, J2) the second layer of paint and the second release layer, separately or together with the second layer of paint, at the fourth location, are at least partly removed.

In accordance with yet an added mode of the process of the invention, that is likewise advantageous for multicolor painting and is therefore preferred, in a step K) the process steps F to J are repeated appropriately, at least once, to apply at least one further layer of paint, once more of a different color, at a further, again different, location.

In accordance with yet an additional mode of the process of the invention, that is likewise advantageous for multicolor painting and is therefore preferred, the third location is the same as the first location and the second layer of paint includes a colorless, translucent, lasering or transparent paint, or the third location is different from the first location and the second layer of paint includes a colored or opaque paint.

In accordance with again another mode of the process of the invention, that is advantageous and is therefore preferred, following the process step B1 or B2 and before the process step C1, an intermediate step B3 from the list of the following intermediate treatments is carried out: exposure to electromagnetic radiation; exposure to heat; exposure to compressed air; exposure to a plasma discharge or corona discharge; exposure to bird feathers, in particular sweeping over therewith, in particular with dust-attracting emu feathers; and exposure to liquid, in particular water.

In accordance with again a further mode of the process of the invention, that is advantageous and is therefore preferred, the medium of the release layer has added to it at least one medium from the list of the following additives: absorbers for electromagnetic radiation, in particular for infrared, near infrared or ultraviolet; initiators; wetting agents; dewetting agents; thickening agents; dispersion aids; solution promoters; and catalysts.

With the objects of the invention in view, there is concomitantly provided a machine, e.g. a painting station disposed in a stationary manner or to be used in a mobile fashion for motor vehicles or body parts of the latter, that is suitable to carry out a process according to the invention, for example as a result of providing the devices proposed for carrying out the respective process steps in this application, such as an application device, radiation source, exposure device, device for paint application, fixing device, cleaning device, in particular a machine having devices which are disposed and/or activated in such a way as to run through the sequence of process steps according to the invention. The machine preferably has one or more 6-axis robot arms each having a change head for at least some of the aforementioned devices.

In the following text, three alternative processes according to the invention are illustrated:

A process for the permanent multicolor painting of a product, e.g. a vehicle body, a part thereof or a metal strip, wherein:
A) on the surface of the product, a first region, a first location within the first region and a second location within the first region but different from the first location are defined;
C1) the surface is provided with a first layer of paint, at least in the first region, preferably an aqueous paint or a stoving paint, and the first layer of paint is exposed to electromagnetic radiation, preferably ultraviolet radiation, at the first location but not at the second location;
E1) the first layer of paint is removed, at least at the second location; and
H1) the surface is provided with a second layer of paint, at least at the second location.

A process for the permanent multicolor painting of a product, wherein:

A) on the surface of the product, a first region, a first location within the first region and a second location within the first region but different from the first location are defined;
B1, B2) the surface is provided with a first adhesion promoter for a first layer of paint, at least in the first region, and the first adhesion promoter is exposed to electromagnetic radiation at the second location but not at the first location;
C1) the surface is provided with a first layer of paint, at least at the first location; and
D) the first layer of paint is fixed, at least at the first location.

A process for the permanent multicolor painting of a product, wherein:

A) on the surface of the product, a first region, a first location within the first region and a second location within the first region but different from the first location are defined;
B1, B2) the surface is provided with a first adhesion promoter for a first layer of paint, at least at the first location but not at the second location, by using an application device;
C1) the surface is provided with the first layer of paint, at least at the first location; and
D) the first layer of paint is fixed, at least at the first location.

Other features which are considered as characteristic for the invention are set forth in the appended claims.

Although the invention is illustrated and described herein as embodied in a process for the permanent multicolor painting of a product, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a flowchart of a preferred exemplary embodiment of a process according to the invention in which structuring of a release layer applied without being structured is carried out;

FIG. 2 is a flowchart of a preferred exemplary embodiment of a process according to the invention in which structuring of a release layer applied without being structured is carried out; and

FIG. 3 is a flowchart of a preferred exemplary embodiment of a process according to the invention in which a structured application of a release layer is carried out.

### DETAILED DESCRIPTION OF THE INVENTION

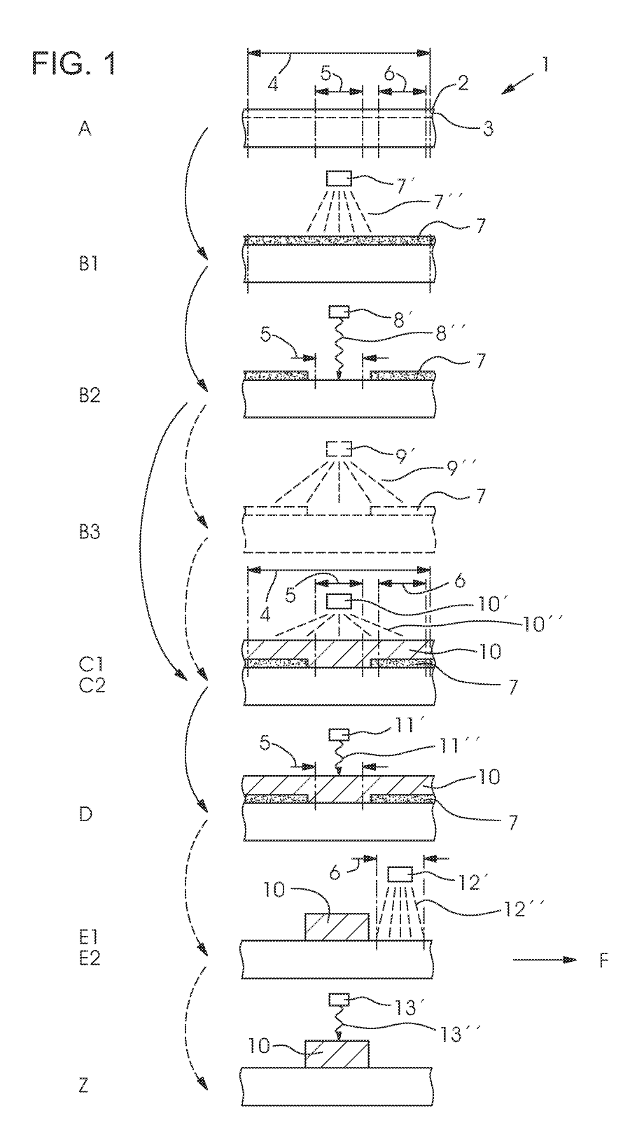

Referring now in detail to the figures of the drawings, in which mutually corresponding elements are provided with the same designations in each case, and first, particularly, to FIG. 1 thereof, there is seen a flowchart of a preferred exemplary embodiment of a process according to the invention, in which structuring of a release layer applied without being structured is carried out. Firstly, a (starting) product 1 or a substrate 1 is provided for the painting according to the invention. At the start of the process, the product which is provided can have an unpainted surface 2 or surface 2 having a base layer of paint 3 already applied, at least within a first region. The base layer of paint and the first layer of paint to be applied thereto have substantially different colors, i.e. bringing about different visual impressions on the finished product painted in accordance with the invention. The product provided in this way can be treated as follows:

A) On the surface 2 of the product 1, a first region 4, a first location 5 within the first region 4 and a second location 6 within the first region 4 but different from the first location 5, are defined. This means that the region and the two locations are determined and fixed for further treatment. Corresponding data needed for extensive automation of the overall process and relating to the form of the surface to be treated can be generated through the use of a preceding 3-D analysis of the surface of the substrate (see the website of the firm Steinbichler Optotechnik GmbH of Neubeuern, Germany, in particular their Automated 3D Digitizing and Optical 3D Measurement Systems) or loaded from an appropriate database. In this way, collisions between the devices used when carrying out the process and the surface can be avoided or distortions of the images to be applied needed due to curved surfaces, for example, can be calculated. However, it is not necessary at this time to mark the region and the two locations on the surface physically and/or chemically through the use of a treatment. The region and the two locations can preferably be defined in accordance with a pattern or image to be produced. In addition, a randomly controlled definition for the subsequent production of random patterns is possible. The first region can be the whole of the (part) surface of the product to be treated. The first and the second locations can together cover the whole of the first region.
B1) The surface 2 is provided with a first release layer 7, at least in the first region 4.

Example: A preferably liquid release agent 7″ is sprayed (through the use of a spraying device 7′) over an area onto a product 1 that is preferably already painted in one color (possibly also painted with a clear top coat), preferably a metal sheet, thus forming an intermediate layer 7 acting as a release layer 7 for the first layer of paint to be applied thereto. The release layer should evaporate easily or decompose above about 200° C. to about 300° C. The release layer is preferably a dual-layer system including firstly “Flüssige Abdeckfolie” [Liquid masking Film] from the firm 3M in Neuss, Germany and secondly (disposed above the latter) the solvent-based preservative wax “Apex 106 II” from the firm Pfinder in Böblingen, Germany. The commercially available product from 3M preferably has added to it 3% by weight of “Luconyl NG Schwarz 0066” (carbon black preparation) from the firm BASF AG, Germany, 1% by weight of “Evonik Tego Wet 240” and 5% by weight of “Tixogel” as additives.

B2) The first release layer 7 is exposed to electromagnetic radiation 8″ from an appropriate device 8′ at the first location 5 but not at the second location 6. As a result, a structuring of the release layer that was applied without being structured occurs, i.e. the previously only defined first location now has, physically and/or chemically, at least one difference from the non-irradiated locations in the first region 4 and that difference is brought about by the irradiation.

Example: Structuring of the release layer 7 by radiation 8″ causes the irradiated location (so-called image points) to be changed as a result of removing or modifying the release agent 7″, for example by becoming more hydrophilic as a result of modification, in order to accept water-based paint better, or, as a result of removal, so that a subsequent application of a paint to the substrate 1 at this location becomes possible. The radiation source 8′ can be a laser, solid body laser, fiber laser, short-pulse laser, diode laser or LEDs. A diode laser or (in order to be able to control the penetration depth better and in this way to prevent damage to the base paint) a short-pulse laser is preferably used.

B3) Optionally, by using an appropriate device 9′ in order to apply a medium 9″, an intermediate step selected from the list of the following intermediate treatments can be carried out:
exposure to electromagnetic radiation 9″,
exposure to heat 9″,
exposure to compressed air 9″,
exposure to a plasma discharge 9″ or corona discharge 9″,
exposure to bird feathers 9″, in particular sweeping over therewith, in particular dust-attracting emu feathers 9″,
exposure to liquid 9″, in particular water 9″.
   C1) The surface 2 is provided with a first layer of paint 10, at least at the first location 5. To this end, an appropriate device 10′, such as a paint atomizer, can be used and can apply an application 10″ of the paint.
   C2) The surface 2 can additionally be provided with a first layer of paint 10, at least at the second location 6. Preferably, the surface 2 in the entire first region 4 is provided with a first layer of paint 10.

Example: An application 10″ of a preferably water-based paint, which bonds or adheres more strongly/better at the image points than at the complementary non-image points, as they are known. In the case of the spray application of the paint, familiar processes can be used, such as rotary atomizers, pneumatic atomizers or compressed air atomizers, with or without electrostatic charging and with or without potential isolation.

D) The first layer of paint 10 is fixed, at least at the first location 5, by using an appropriate fixing device 11′, preferably a drying or curing device.

Example: A pre-curing, partial curing or curing 10″ of the paint with conventional drying processes and corresponding dryers 11′ (e.g. hot air, NIR, IR, UV and/or electron beam devices 11″) is carried out, with the release layer 7 applied in accordance with step B1 and structured in accordance with step B2, remaining substantially unchanged.

E1) The first layer of paint 10 can be removed, at least partly and actively, at the second location 6 by using an appropriate cleaning device 12′ and a suitable cleaning medium 12″.
E2) The first release layer 7 can be removed, at least partly and actively, together with the first layer of paint 10 or separately, at the second location 6 by using the same or a separate cleaning device 12′.

Example: A partial or substantially residue-free rubbing off or washing off of the release layer 7 which is retained substantially unchanged at the second location 6, with the paint 10″ borne by the release layer (at the non-image points, as they are known) preferably being removed substantially without residue, e.g. through the use of a device 12′ which applies gas, vapor or liquid 12″ to the surface 2, preferably at high pressure and/or elevated temperature. The liquid preferably has additives, such as wetting agents and surfactants, added thereto.

Z) At the end of the process, permanent fixing of the first layer of paint 10 can be carried out by using an appropriate fixing device 13′, preferably a drying or curing device and particularly preferably a device 13′ using electromagnetic radiation 13″.

Example: A post-curing or partial curing is carried out once more and, as a result, curing of the paint 10 remaining at the first location 5 (at the image points, as they are known) with conventional drying processes and corresponding dryers 13′ (e.g. using hot air, NIR, IR, UV and/or electron beam 13″).

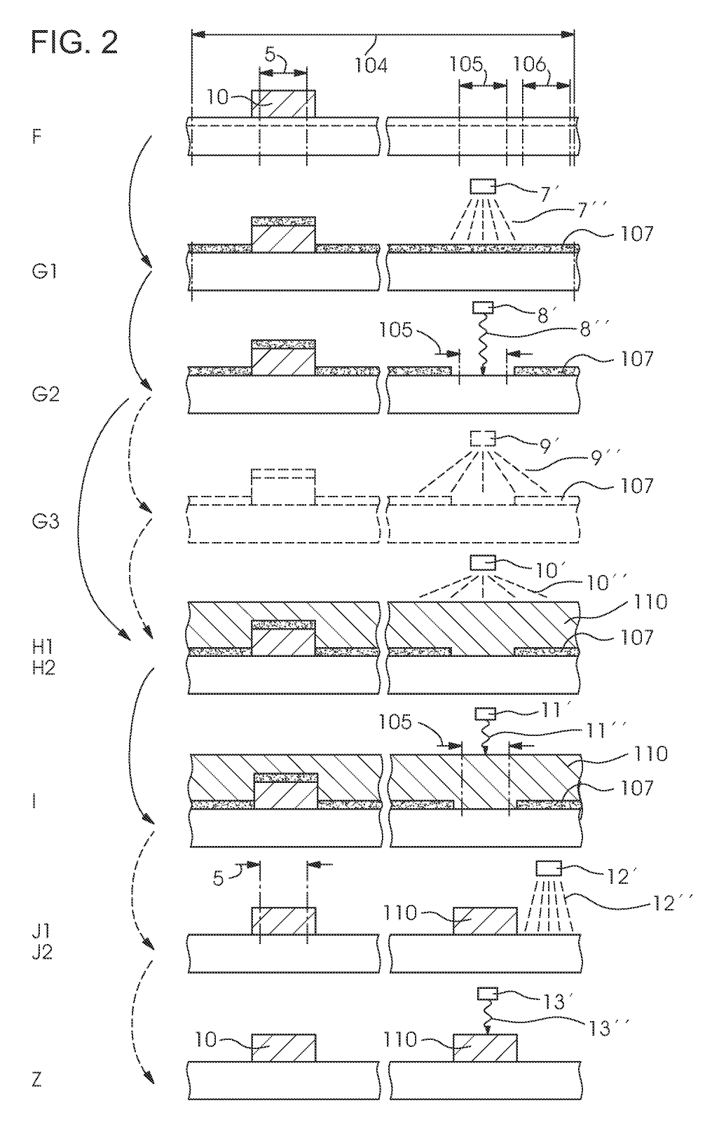

As an alternative to ending the process according to process step Z, the process can be carried out again with a further paint of a different color in accordance with the illustration in FIG. 2.

F) A third location 105 within a second region 104 and a fourth location 106 within the second region but different from the third location, are defined on the surface 2. The second region 104 can thereby be different from the first region 4 or can include the first region partly or wholly (as illustrated). The two regions can also be substantially identical.
G1) The surface 2 is provided with a second release layer 107, at least in the second region 104.
G2) The second release layer 107 is exposed to electromagnetic radiation 8″ at the third location 105.
G3) Optionally, by using an appropriate device 9′, an intermediate step corresponding to process step B3 can be carried out.
H1, H2) The surface 2 is provided with a second layer of paint 110, at least at the third and at the fourth locations 105, 106, with the first layer of paint and the second layer of paint having different colors.
I) The second layer of paint 110 is fixed, at least at the third location 105.
J1, J2) The second layer of paint 110 and the second release layer 107, together with the second layer of paint or separately, can be removed, at least partly and actively, at the fourth location 106. The fourth location preferably includes at least the first location 5, so that the first layer of paint 10 previously applied at the first location is exposed again substantially without residue.
K) The process steps F to J can be repeated appropriately, at least once, to apply at least one further layer of paint 210, once more of a different color, at a further location 205, which is again different.
Z) At the end of the process, permanent fixing of the second layer of paint 110 can be carried out.

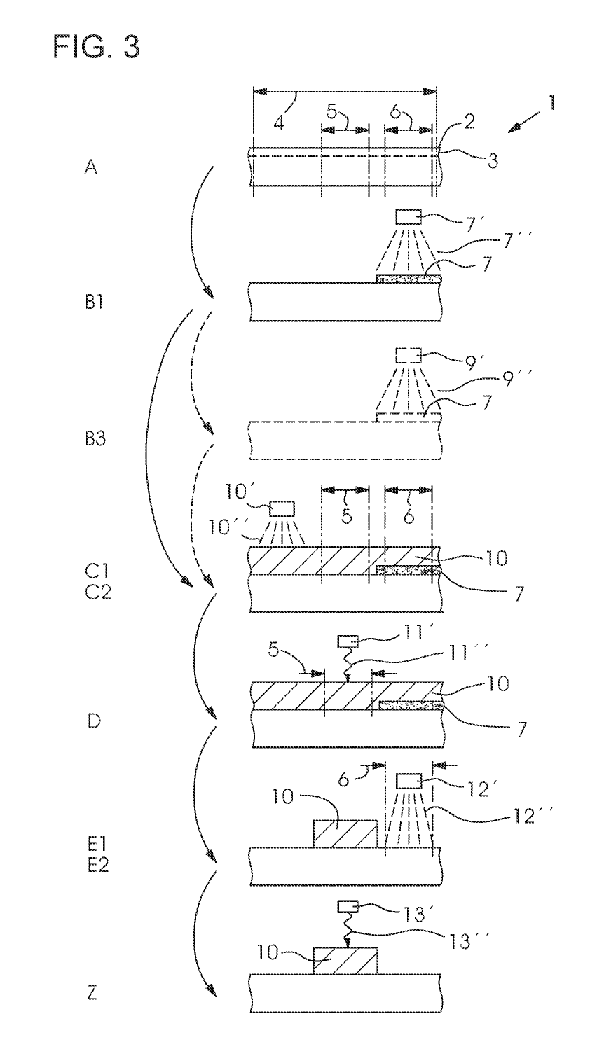

FIG. 3 shows a flowchart of a preferred exemplary embodiment of a process according to the invention in which structured application of a release layer is carried out.

Firstly, as in the process illustrated in FIG. 1, a (starting) product 1 or substrate 1 that is unpainted or provided with a base paint is provided for the painting according to the invention. The product provided in this way can be treated as follows:

A) first region 4, a first location 5 within the first region and a second location 6 within the first region but different from the first location are defined on the surface 2 of the product 1, as in the process step A illustrated in FIG. 1.
B1) The surface 2, as in the process step B1 illustrated in FIG. 1, is provided with a first release layer 7, at least at the second location 6, but not at the first location 5, by using an application device 7′.

Example: An application of a preferably liquid release agent 7″ and thus of an intermediate layer 7 acting as a release layer 7 for the first layer of paint to be applied thereto is carried out through the use of devices 7′ producing a jet (continuously) or droplets (interrupted), wherein it is possible for all of the release agents mentioned above (see the definition of “release layer”) to be used. The above-mentioned layer of wax or oil can preferably be applied with an ink-jet system of the Galaxy PH, 256/80 HM type from the firm Fuji, heated to about 90° C.

B3) Optionally, as in the process step B3 illustrated in FIG. 1, an intermediate step can be carried out.
C1, C2) The surface 2, as in the process step C1, C2 illustrated in FIG. 1 and in the example described in association therewith, is provided with a first layer of paint 10, at least at the first location 5 and in addition at least at the second location 6.
D) The first layer of paint 10, as in the process step D illustrated in FIG. 1 and in the example described in association therewith, is fixed, at least at the first location 5.
E1) The first layer of paint 10, as in the process step E1 illustrated in FIG. 1, can be removed, at least partly and actively, at the second location 6.
E2) The first release layer 7, as in the process step E2 illustrated in FIG. 1 and in the example described in association therewith and also together with the first layer of paint 10 or separately, can be removed, at least partly and actively, at the second location 6.
Z) At the end of the process, as in the process step Z illustrated in FIG. 1 and in the example described in association therewith, permanent fixing of the first layer of paint can be carried out.

As an alternative to ending the process in accordance with process step Z, the process illustrated in FIG. 3 can be carried out again with a further paint 110″ of a different color from the first paint 10″. To this end, as in the process illustrated in FIG. 3, a third location 105 within a second region 104 and a fourth location 106 within the second region but different from the third location, are defined and treated in accordance with the process steps G1, G3, H1, H2, I and J1, J2, illustrated in FIG. 2. In this case, the release layer 107 is applied at least at the fourth location 106 but not at the third location 105. In addition, repetition in accordance with the process step K illustrated in FIG. 2 and final permanent fixing in accordance with the process step Z illustrated in FIG. 2, are possible.

1. A process for the permanent multicolor painting of a product, the process comprising the following steps:
A) defining a first region, a first location within the first region and a second location within the first region but different than the first location, on a surface of the product;
B1, B2) providing the surface with a first release layer at least in the first region, and exposing the first release layer to electromagnetic radiation at the first location but not at the second location;
C1) providing the surface with a first layer of paint, at least at the first location; and
D) fixing the first layer of paint, at least at the first location.

2. The process according to claim 1, which further comprises:
A) providing the surface with a base layer of paint, at least within the first region, at a start of the process, the base layer of paint and the first layer of paint having different colors.

3. The process according to claim 1, which further comprises:
Z) carrying out permanent fixing of the first layer of paint at an end of the process.

4. The process according to claim 1, which further comprises:
C2) providing the surface with the first layer of paint, at least at the second location; and
E1) at least partly removing the first layer of paint at the second location.

5. The process according to claim 4, which further comprises:
E2) at least partly removing the first release layer, separately or together with the first layer of paint, at the second location.

6. The process according to claim 5, which further comprises:
F) defining a third location within a second region and a fourth location within the second region but different than the third location, on the surface;
G1, G2) providing the surface with a second release layer at least in the second region, and exposing the second release layer to electromagnetic radiation at the third location;
H1, H2) providing the surface with a second layer of paint, at least at the third and at the fourth locations, the first layer of paint and the second layer of paint having different colors;
I) fixing the second layer of paint, at least at the third location; and
J1, J2) at least partly removing the second layer of paint and the second release layer, separately or together with the second layer of paint, at the fourth location.

7. The process according to claim 6, which further comprises:
K) repeating process steps F, G1, G2, H1, H2, I, J1 and J2 according to claim 7 and/or the process steps F, G1, H1, H2, I, J1 and J2 according to claim 8 as necessary, at least once, to apply at least one further layer of paint of a different color at a different location.

8. The process according to claim 6, wherein:
the third location is the same as the first location and the second layer of paint includes a colorless, translucent, lasering or transparent paint; or
the third location is different than the first location and the second layer of paint includes a colored or opaque paint.

9. The process according to claim 1, which further comprises:
carrying out an intermediate step B3 in accordance with process step B2 according to claim 1 or in accordance with process step B1 according to claim 2 and before process step C1, from the following list of intermediate treatments:
exposure to electromagnetic radiation,
exposure to heat,
exposure to compressed air,
exposure to a plasma discharge or corona discharge,
exposure to bird feathers, and
exposure to liquid.

10. The process according to claim 9, wherein the exposure to bird feathers is carried out by sweeping over with the feathers.

11. The process according to claim 10, wherein the exposure to bird feathers is carried out with dust-attracting emu feathers

12. The process according to claim 9, wherein the liquid is water.

13. The process according to claim 1, which further comprises:
adding to the medium of the release layer at least one medium from the following list of additives:
absorbers for electromagnetic radiation,
initiators,
wetting agents,
dewetting agents,
thickening agents,
dispersion aids,
solution promoters,
catalysts.

14. The process according to claim 13, wherein the radiation is selected from the group consisting of infrared, near infrared and ultraviolet.

15. A process for the permanent multicolor painting of a product, the process comprising the following steps:
A) defining a first region, a first location within the first region and a second location within the first region but different than the first location, on a surface of the product;
B1) providing the surface with a first release layer, at least at the second location but not at the first location, by using an application device;
C1) providing the surface with a first layer of paint, at least at the first location; and
D) fixing the first layer of paint, at least at the first location.

16. The process according to claim 15, which further comprises:
A) providing the surface with a base layer of paint, at least within the first region, at a start of the process, the base layer of paint and the first layer of paint having different colors.

17. The process according to claim 15, which further comprises:
Z) carrying out permanent fixing of the first layer of paint at an end of the process.

18. The process according to claim 15, which further comprises:
C2) providing the surface with the first layer of paint, at least at the second location; and
E1) at least partly removing the first layer of paint at the second location.

19. The process according to claim 18, which further comprises:
E2) at least partly removing the first release layer, separately or together with the first layer of paint, at the second location.

20. The process according to claim 19, which further comprises:
F) defining a third location within a second region and a fourth location within the second region but different than the third location, on the surface;
G1) providing the surface with a second release layer, at least at the fourth location, by using an application device;
H1, H2) providing the surface with a second layer of paint, at least at the third location and at the fourth location, the first layer of paint and the second layer of paint having different colors;
I) fixing the second layer of paint, at least at the third location; and
J1, J2) at least partly removing the second layer of paint and the second release layer, separately or together with the second layer of paint, at the fourth location.

21. The process according to claim 20, which further comprises:
K) repeating process steps F, G1, G2, H1, H2, I, J1 and J2 according to claim 7 and/or the process steps F, G1, H1, H2, I, J1 and J2 according to claim 8 as necessary, at least once, to apply at least one further layer of paint of a different color at a different location.

22. The process according to claim 20, wherein:
the third location is the same as the first location and the second layer of paint includes a colorless, translucent, lasering or transparent paint; or
the third location is different than the first location and the second layer of paint includes a colored or opaque paint.

23. The process according to claim 15, which further comprises:
carrying out an intermediate step B3 in accordance with process step B2 according to claim 1 or in accordance with process step B1 according to claim 2 and before process step C1, from the following list of intermediate treatments:
exposure to electromagnetic radiation,
exposure to heat,
exposure to compressed air,
exposure to a plasma discharge or corona discharge,
exposure to bird feathers, and
exposure to liquid.

24. The process according to claim 23, wherein the exposure to bird feathers is carried out by sweeping over with the feathers.

25. The process according to claim 24, wherein the exposure to bird feathers is carried out with dust-attracting emu feathers

26. The process according to claim 23, wherein the liquid is water.

27. The process according to claim 15, which further comprises:
adding to the medium of the release layer at least one medium from the following list of additives:
absorbers for electromagnetic radiation,
initiators,
wetting agents,
dewetting agents,
thickening agents,
dispersion aids,
solution promoters,
catalysts.

28. The process according to claim 27, wherein the radiation is selected from the group consisting of infrared, near infrared and ultraviolet.
